(19) United States
(12) Patent Application Publication
(10) Pub. No.: US 2009/0285577 A1
(43) Pub. Date: Nov. 19, 2009

(54) Optical Frontend for Integration of Optical and Wireless Networks

(75) Inventors: Jianjun Yu, Princeton, NJ (US); Philip Nan Ji, Princeton, NJ (US); Lei Xu, Princeton, NJ (US); Ting Wang, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/119,884

(22) Filed: May 13, 2008

(51) Int. Cl. H04J 14/02

(52) U.S. Cl. 398/79

(57) ABSTRACT

Data is transmitted by radio over fiber in a wavelength division multiplex optical transmission system. Data is transmitted over a single optical channel by directly modulating a single wavelength laser with a baseband data signal. Multiple single wavelength laser beams are multiplexed into a single multi-wavelength laser beam. All of the single optical channels are up-converted to RF frequencies by modulating the intensity of the multi-wavelength laser beam with an RF carrier.

### BACKGROUND OF THE INVENTION

The present invention relates generally to fiber optic transmission systems, and more particularly to optical frontends for integration of optical and wireless networks.

Fiber optics is a reliable technology which has been widely deployed in telecommunications networks. Until recently, fiber optics was used primarily within a core network for long-haul communication links. Multimedia services (data, voice, and video) are increasingly being provided over packet data networks. These services require high-speed communication links between customers' equipment and the core network. Since optical fiber inherently has higher bandwidth and lower loss than traditional twisted-pair cable or coaxial cable, it is being deployed out to the customer premises.

Another rapidly growing segment in telecommunications is wireless networks, which are undergoing an evolution similar to fiber optic networks. Until recently, wireless communications was primarily associated with voice communications in wide-area cellular networks. Increasingly, however, multimedia services are being provided to consumers via mobile units such as laptops and cell phones with data and video capabilities. As these mobile services grow in popularity, wireless networks must be upgraded to handle both the increase in the number of subscribers/unit area and the bandwidth/subscriber. This need is being addressed by microcell networks. There are various architectures for microcells. Microcells, for example, may be provisioned by extending wide-area cellular networks to cover small areas via low-power base stations. Microcells may also be provisioned through wireless local area networks (WLANs), such as Wi-Fi networks. Consumer wireless equipment connect to WLANs via wireless access points. Multiple wireless access points may be interconnected to provide wider coverage and to support seamless roaming.

Regardless of the architecture used for broadband wireless services, there is a need for a high-speed backhaul network to transport packet data (and associated multimedia content) from wireless base stations and access points to a central office or to a server (in a local area or wide-area network, for example). As discussed above, fiber optics inherently has high bandwidth and low loss. And, since it is being deployed out to the customer premises, integrating fiber optic and wireless networks becomes an attractive technical solution. Cost, however, becomes a critical factor in implementing this solution. The cost of fiber optic equipment in core networks and the cost of base stations in a wide-area cellular network are shared by a large number of subscribers. For mass deployment of broadband services in a microcellular network, however, the base stations, access points, and associated network must be low cost. In particular, low cost transceivers are needed for integration of optical and wireless networks.

### BRIEF SUMMARY OF THE INVENTION

Data is transmitted by radio over fiber in a wavelength division multiplex optical transmission system. Data is transmitted over a single optical channel by directly modulating a single wavelength laser with a baseband data signal. Multiple single wavelength laser beams are multiplexed into a single multi-wavelength laser beam. The single optical channels are up-converted to RF frequencies by modulating the intensity of the multiplexed laser beam with an RF carrier. In an embodiment, the intensity of the multiplexed laser beam is modulated by transmitting the multiplexed laser beam through an intensity modulator. The transmittance of the intensity modulator is modulated with an RF carrier.

These and other advantages of the invention will be apparent to those of ordinary skill in the art by reference to the following detailed description and the accompanying drawings.

### BRIEF DESCRIPTION OF THE DRAWINGS

FIG. 1 shows a high-level schematic of a standard wide-area cellular network;

FIG. 2 shows a high-level schematic of an integrated optical and wireless network;

FIG. 3(a)-FIG. 3(d) show high level schematics of laser modulation schemes;

FIG. 4 shows a high-level schematic of a wavelength division multiplex optical source with direct modulated lasers driven at carrier frequencies;

FIG. 5 shows a high-level schematic of a wavelength division multiplex optical source with direct modulated lasers driven at baseband frequencies; and

FIG. 6 shows a flowchart of steps for generating a modulated multi-wavelength laser beam.

### DETAILED DESCRIPTION

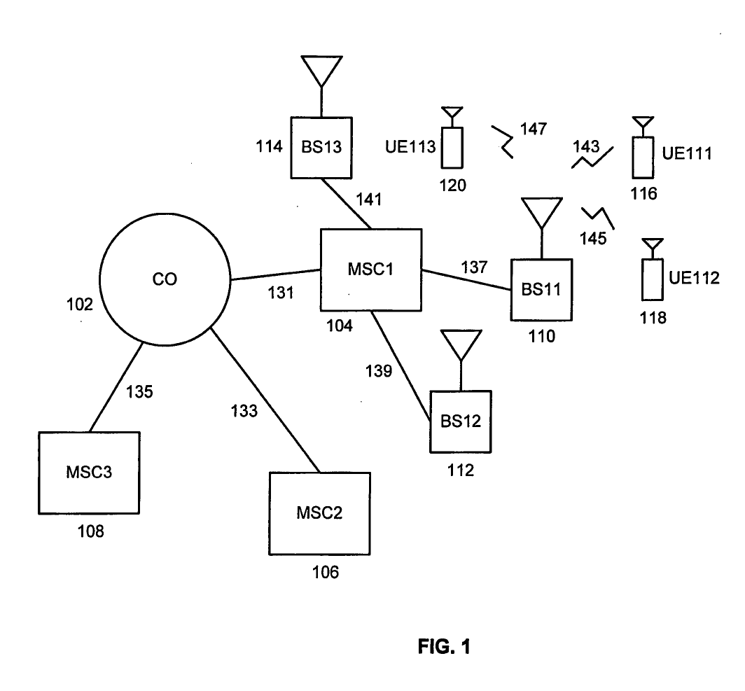

Shown in FIG. 1 is a high-level schematic of a standard wide-area cellular network. Multiple mobile switching centers (MSCs), MSC1 104-MSC3 108, are connected to central office CO 102 via communication links 131-135, respectively. These communication links, for example, may be connections to a SONET ring. In turn, multiple base stations (BSs) are connected to each MSC. For example, base stations BS11 110-BS13 114 are connected to MSC1 104 via communication links 137-141, respectively. These communication links, for example, may be T1/E1 trunks. Each base station contains a radiofrequency (RF) transceiver, also referred to as a radio frontend, which communicates with a RF transceiver in a customer's user equipment (UE). User equipment, for example, may be a cell phone or a laptop outfitted with a wireless modem. In FIG. 1, user equipment UE111 116-UE113 120 communicate with base station BS11 110 via wireless links 143-147, respectively.

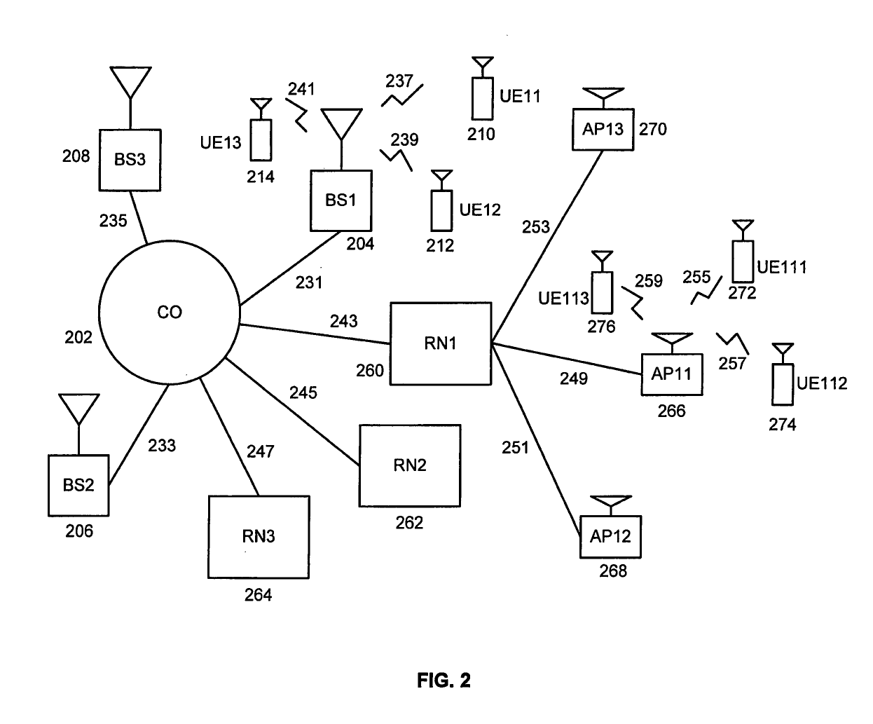

Shown in FIG. 2 is a high-level schematic of an example of an integrated optical and wireless network. Absent are the mobile switching centers. Multiple base stations, BS1 204-BS3 208, connect directly with central office CO 202 via fiber optic links 231-235, respectively. As shown previously in FIG. 1, multiple user equipment communicate with a base station. For example, user equipment UE11 210-UE13 214 communicate with base station BS1 204 via wireless links 237-241, respectively.

Shown in FIG. 2 are new network elements, remote nodes RN1 260-RN3 264, which connect directly with CO 202 via fiber optic links 243-247, respectively. A remote node aggregates traffic from multiple access points, and reduces the number of fiber runs from the central office to customer premises. In FIG. 2, access points AP11 266-AP13 270 communicate with remote node RN1 260 via fiber optic links 249-253, respectively. Remote node RN1 260, for example, may be a neighborhood node, and access points AP11 266-AP13 270 may be located within customer premises. Multiple user equipment communicate with an access point. For example, user equipment UE111 272-UE113 276 communicate with access point AP11 266 via wireless links 255-259, respectively. Similarly, RN2 262 and RN3 264 agregate traffic from other access points (not shown in FIG. 2).

One technique for integrating fiber optic and wireless networks is radio over fiber. In this technique, an optical carrier is first modulated at the RF operating frequency of the wireless network. The RF frequency carrier is then modulated with baseband data signal. To minimize the costs of the base stations and access points, it is advantageous to perform as much of the signal processing as possible at the central office or remote node. For example, downstream signals may be transmitted from the central office to a base station by intensity modulation of an optical beam. At the base station an optical transceiver converts the optical signal to the RF signal used for the wireless transmission network. Upstream transmission may be simplified by various schemes involving reuse of a downstream carrier.

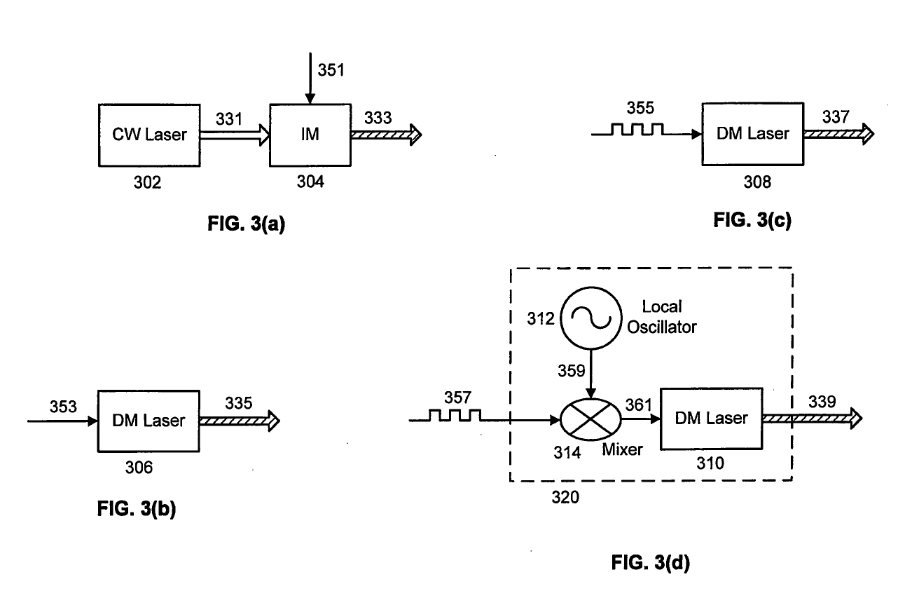

FIG. 3(a)-FIG. 3(d) show high-level schematics of various laser modulation schemes that may be used in an integrated fiber optic and wireless network. In FIG. 3(a), continuous wave (CW) laser 302 emits constant intensity laser beam 331, which is transmitted through intensity modulator (IM) 304. The transmittance of IM 304 is a function of a voltage applied across it. In FIG. 3(a), the transmittance of IM 304 is modulated by radiofrequency (RF) drive signal 351. The resulting modulated laser beam is laser beam 333. The modulation scheme shown in FIG. 3(a) is capable of high bandwidth modulation, but IM 304 is an expensive component, such as a lithium niobate intensity modulator. If lower bandwidth (for example, 40 Gbits/sec or less) is adequate, FIG. 3(b) shows a more economical technique in which direct modulated (DM) laser 306 is directly modulated by drive signal 353. The resulting modulated laser beam is laser beam 335. In embodiments of the invention, direct modulated lasers are used to reduce costs.

In FIG. 3(c), DM laser 308 is directly modulated with baseband data signal 355. Baseband data signal 355 is generated by a data source (not shown). A data source, for example, may include a digital processor and associated signal processing elements and software. The baseband data signal, for example, may have a bandwidth of 2.5 Gbits/sec. The resulting modulated laser beam is laser beam 337. In an embodiment, baseband data signal 355 uses on/off key (OOK) modulation. One skilled in the art may develop embodiments which use other modulation schemes, such as phase shift key, frequency shift key, and orthogonal frequency division multiplexing (OFDM).

In FIG. 3(d), the baseband data signal 357 is mixed with RF carrier 359 via mixer 314. This mixing process is referred to as RF up-conversion (or, simply, up-conversion). RF carrier 359 is generated by local oscillator (LO) 312. RF carrier 359, for example, may be a sinusoidal signal. Herein, an RF carrier may also refer to a carrier with a higher frequency, such as microwave and mm-wave carriers. The modulated RF carrier 361 then drives DM laser 310. The resulting modulated laser beam is laser beam 339. DM laser 310 requires a higher bandwidth than DM laser 308. In general, the cost of a DM laser increases with bandwidth. Herein, the combination of a DM laser, mixer, and local oscillator is referred to as a high-bandwidth DM laser optical source (HDMLOS). For example, the combination of DM laser 310, mixer 314, and local oscillator 312 is shown as high-bandwidth DM laser optical source HDMLOS 320 in FIG. 3(d). Multiple high-bandwidth DM laser optical sources may be cost-effective optical sources for a network deploying a small number of optical sources. For a network deploying a large number of optical sources, as discussed below, however, more cost-effective optical sources are desirable.

Higher data rates across a single fiber optic link may be achieved by wavelength division multiplexing (WDM). In this scheme, an optical communication channel is carried across an optical beam with a single wavelength. Multiple single-wavelength optical beams are multiplexed into a single multi-wavelength optical beam, which is then transmitted across an optical fiber. At the receiving end, the multi-wavelength optical beam is demultiplexed into its individual single-wavelength optical channels.

For example, referring back to FIG. 2, WDM may be deployed across fiber optic link 231 to provide higher bandwidth between base station BS1 204 and central office CO 202, thus permitting BS1 204 to service a larger number of user equipment (such as UE11 210) with higher bandwidth. Similarly, WDM may be deployed across fiber optic link 249 to provide higher bandwidth between access point AP11 266 and remote node RN1 260, thus permitting AP11 266 to service a larger number of user equipment (such as UE111 272) with higher bandwidth. As a last example, WDM may be deployed across fiber optic link 243 to provide higher bandwidth between remote node RN1 260 and CO 202, thus permitting RN1 260 to aggregate higher bandwidth traffic from a larger number of access points (such as AP11 266).

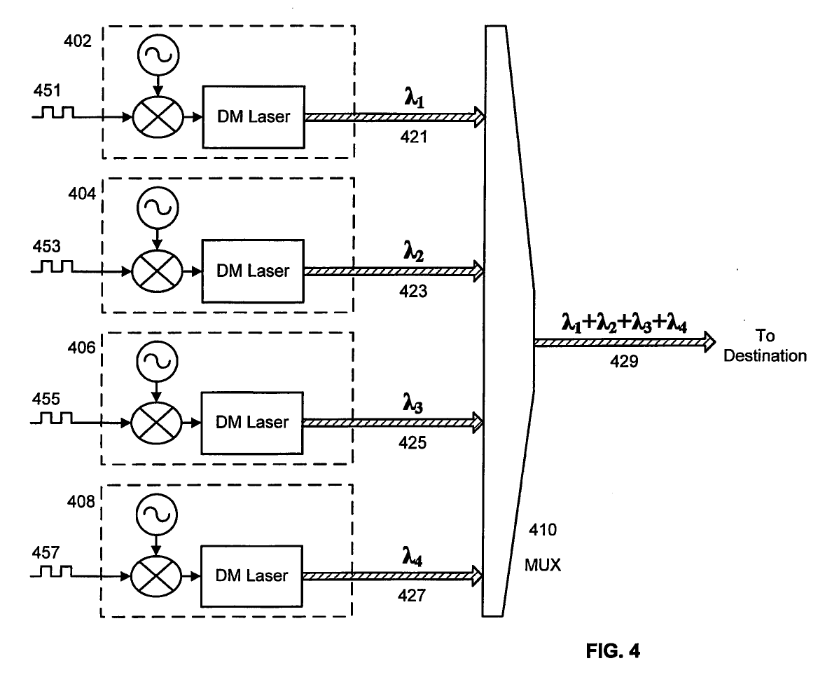

FIG. 4 shows a schematic of a WDM optical transmission system using four individual HDMLOSs (HDMLOS 402-HDMLOS 408), emitting single-wavelength optical beams with wavelengths λ₁-λ₄, respectively. Baseband data signal 451-baseband data signal 457 are input into HDMLOS 402-HDMLOS 408, respectively. As previously shown in FIG. 3(d), within a HDMLOS, the baseband data signal is up-converted by mixing it with an RF carrier. The output of the HDMLOS is a modulated single-wavelength laser beam. In FIG. 4, the resulting modulated laser beams are laser beam 421-laser beam 427, with wavelengths λ₁-λ₄, respectively. Laser beam 421-laser beam 427 are multiplexed by MUX 410, which, for example, may be an arrayed waveguide grating (AWG). The resulting multi-wavelength laser beam 429 is transmitted across optical fiber to an end destination, such as a base station (not shown).

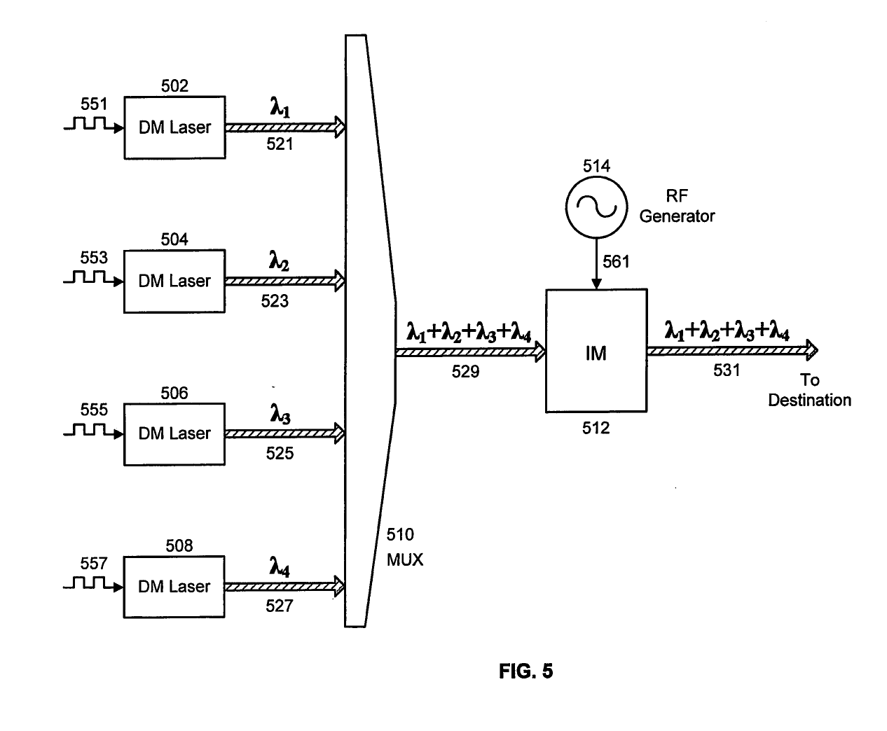

For a WDM system with a large number of wavelengths, FIG. 5 shows an embodiment using DM lasers modulated at baseband frequencies only. For simplicity, only four wavelengths are shown. In general, however, the number of wavelengths depends on the optical characteristics of multiplexer MUX 510 and intensity modulator IM 512 (described below), and other optical parameters, such as the linewidth of an optical beam. For example, forty or more wavelengths may be multiplexed together. DM laser 502-DM laser 508 emit at wavelengths λ₁-λ₄, respectively. Baseband data signal 551-baseband data signal 557 drive DM laser 502-DM laser 508, respectively. The resulting modulated laser beams are laser beam 521-laser beam 527, with wavelengths λ₁-λ₄, respectively. Laser beam 521-laser beam 527 are multiplexed by MUX 510, which may, for example, be an arrayed waveguide. Multi-wavelength laser beam 529 (with wavelengths λ₁+λ₂+λ₃+λ₄) is transmitted through intensity modulator IM 512, which may, for example, be a lithium niobate intensity modulator. Other modulators, such as electroabsorption modulators, may be used. The transmittance of IM 512 is modulated by RF drive signal 561, which is generated by RF generator 514. All four baseband data signals, baseband data signal 551-baseband data signal 557, are up-converted by a single optical component, IM 512. Embodiments may use different modulation schemes for IM 512. Examples include single sideband, double sideband, vestigial sideband, and optical carrier suppression. Note that even if IM 512 is an expensive component, the overall system cost of the system shown in FIG. 5 may be less than that of the system in FIG. 4 because a single external modulator services an array of low-cost DM lasers.

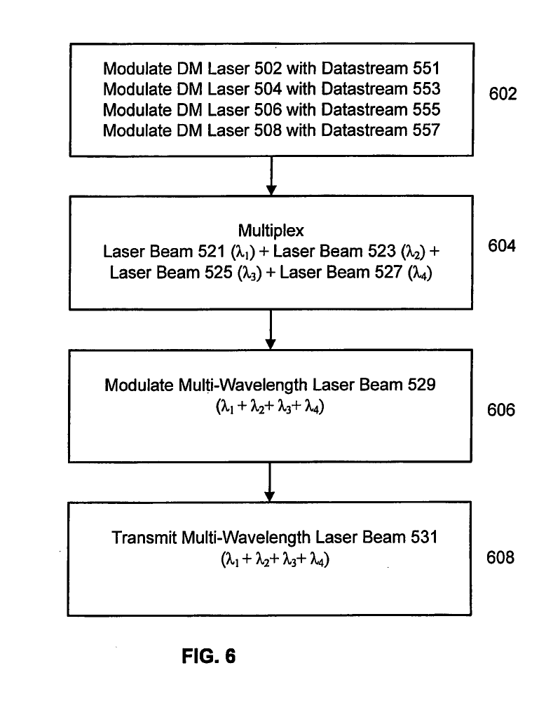

FIG. 6 shows a high-level flowchart of steps, according to an embodiment, for transporting data via radio over fiber in a WDM transmission system. In step 602, each DM laser (emitting at a single wavelength λ) is modulated with a baseband data signal. For example, referring to FIG. 5, DM laser 502-DM laser 508, emitting at wavelengths λ₁-λ₄, respectively, are modulated by baseband data signal 551-baseband data signal 557, respectively. The process then passes to step 604, in which the modulated laser beams are multiplexed into a multi-wavelength laser beam. For example, referring to FIG. 5, laser beam 521-laser beam 527 are multiplexed by MUX 510 into multi-wavelength laser beam 529. The process then passes to step 606, in which the multi-wavelength laser beam is modulated to up-convert all four wavelengths simultaneously. For example, referring to FIG. 5, laser beam 529 is modulated by intensity modulator 512, which is driven by RF drive signal 561, generated by RF generator 514. The process then passes to step 608, in which the up-converted multi-wavelength laser beam is transmitted across an optical fiber to an end destination. For example, referring to FIG. 5, up-converted multi-wavelength laser beam 531 is transmitted across an optical fiber to a base station (not shown).

Note that the modulation scheme shown in FIG. 5 has been discussed for downstream transmission from a central office to a customer premises, as shown in FIG. 2. In an embodiment, the modulation scheme shown in FIG. 5 may also be used for upstream transmission from multiple customer premises to a central office. For example, DM laser 502-DM laser 508 may be optical sources located in four separate customer premises. To maintain low cost, DM laser 502-DM laser 508 are directly modulated by baseband data signal 551-baseband data signal 557. The individual output laser beams, laser beam 521-laser beam 527, are transmitted via separate optical fibers to multiplexer MUX 510. The output multi-wavelength laser beam 529 is then up-converted by the single intensity modulator IM 512, which is driven by RF drive signal 561, generated by RF generator 514. The output of IM 512, laser beam 531, is then transmitted to an end destination. For example, if MUX 510, IM 512, and RF generator 514 are located in the central office, the destination will be a demultiplexer and a bank of individual receivers. As another example, if MUX 510, IM 512, and RF generator 514 are located in a remote node, the destination will be a central office.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for transmitting data by radio over fiber, comprising the steps of:
directly modulating a first laser having a first wavelength with a first baseband data signal to generate a first modulated laser beam;
directly modulating a second laser having a second wavelength with a second baseband data signal to generate a second modulated laser beam;
multiplexing said first modulated laser beam and said second modulated laser beam into a multiplexed laser beam; and
modulating said multiplexed laser beam with a radiofrequency (RF) carrier to generate a modulated multiplexed laser beam; and
transmitting said modulated multiplexed laser beam over optical fiber.

2. The method of claim 1, wherein said step of modulating said multiplexed laser beam with a radiofrequency (RF) carrier further comprises the steps of:
transmitting said multiplexed laser beam through an intensity modulator; and
modulating the transmittance of said intensity modulator with said RF carrier.

3. The method of claim 1, wherein said step of multiplexing said first modulated laser beam and said second modulated laser beam further comprises the step of:
multiplexing said first modulated laser beam and said second modulated laser beam with an arrayed waveguide grating.

4. The method of claim 1, wherein said step of directly modulating a first laser further comprises the step of:
directly modulating said first laser with on/off key modulation.

5. The method of claim 1, wherein said step of directly modulating a first laser further comprises the step of:
directly modulating said first laser with phase shift key modulation.

6. The method of claim 1, wherein said step of directly modulating a second laser further comprises the step of:
directly modulating said second laser with on/off key modulation.

7. The method of claim 1, wherein said step of directly modulating a second laser further comprises the step of:
directly modulating said second laser with phase shift key modulation.

8. Apparatus for transmitting data by radio over fiber comprising:
means for directly modulating a first laser having a first wavelength with a first baseband data signal to generate a first modulated laser beam;
means for directly modulating a second laser having a second wavelength with a second baseband data signal to generate a second modulated laser beam;
means for multiplexing said first modulated laser beam and said second modulated laser beam into a multiplexed laser beam;
means for modulating said multiplexed laser beam with a radiofrequency (RF) carrier to generate a modulated multiplexed laser beam; and
means for transmitting said modulated multiplexed laser beam over optical fiber.

9. The apparatus of claim 8, wherein said means for modulating said multiplexed laser beam with a radiofrequency (RF) carrier further comprises:
an intensity modulator.

10. The apparatus of claim 8, wherein said means for multiplexing said first modulated laser beam and said second modulated laser beam further comprises:
an arrayed waveguide grating.

11. The apparatus of claim 8, wherein said means for directly modulating a first laser further comprise:
means for directly modulating a first laser with on/off key modulation.

12. The apparatus of claim 8, wherein said means for directly modulating a first laser further comprise:
means for directly modulating a first laser with phase shift key modulation.

13. The apparatus of claim 8, wherein said means for directly modulating a second laser further comprise:
means for directly modulating a second laser with on/off key modulation.

14. The apparatus of claim 8, wherein said means for directly modulating a second laser further comprise:
means for directly modulating a second laser with phase shift key modulation.

15. Apparatus for transmitting data by radio over fiber comprising:
a first laser configured to generate a first laser beam having a first wavelength in response to a first baseband data signal;
a second laser configured to generate a second laser beam having a second wavelength in response to a second baseband data signal;
a multiplexer configured to multiplex said first modulated laser beam and said second laser beam into a multiplexed laser beam;
an intensity modulator configured to modulate said multiplexed laser beam in response to an RF carrier.

16. The apparatus of claim 15, wherein said multiplexer is an arrayed waveguide grating.

17. The apparatus of claim 15, wherein said intensity modulator is an electro-absorption modulator.
